(19) United States
(12) Patent Application Publication
(10) Pub. No.: US 2010/0307167 A1
(43) Pub. Date: Dec. 9, 2010

(54) CENTRIFUGAL DE-OILER OF VARIABLE FLOW SECTION

(75) Inventor: Serge Rene Morreale, Guignes (FR)

Correspondence Address: OBLON, SPIVAK, MCCLELLAND MAIER & NEUSTADT, L.L.P., 1940 DUKE STREET, ALEXANDRIA, VA, 22314, US

(73) Assignee: SNECMA, Paris (FR)

(21) Appl. No.: 12/867,506

(22) PCT Filed: Mar. 11, 2009
(86) PCT No.: PCT/FR2009/050400

§ 371 Date: Aug. 13, 2010

(30) Foreign Application Priority Data
Mar. 12, 2008 (FR) 0851608

(51) Int. Cl. F02C 6/00; B01D 45/12

(52) U.S. Cl. 60/801; 55/409

(57) ABSTRACT

A centrifugal de-oiler of variable flow section, the de-oiler including a hollow shaft that is movable in rotation. The shaft includes at least one air-passing orifice and a piston housed in the shaft so as to subdivide the inside of the shaft into two compartments that are sealed relative to each other. One compartment includes the air-passing orifice(s) being subjected to ambient pressure, and the other compartment is subjected to varying pressure in the air/oil enclosure. The piston is configured to move in translation inside the shaft between two extreme positions under effect of the pressure difference between the two compartments, the extreme position including a first position in which the air-passing orifice(s) is/are disengaged, and a second position in which the air-passing orifice(s) is/are partially obstructed by the piston.

### BACKGROUND OF THE INVENTION

The present invention relates to the general field of devices enabling the air of an air/oil mixture to be separated from the oil of the mixture. A particular field of application of the invention is that of gas turbine airplane engines (turbojets and turboprops).

Gas turbine airplane engines have enclosures containing ball bearings and gears that are lubricated and cooled by oil. In order to avoid oil leaking out from those enclosures, seals are arranged between the rotary portions and the stationary portions of the enclosures, or indeed between different rotary portions. Amongst the available sealing technologies, those that provide the longest lifetimes are labyrinth seals and brush seals, there being no contact in labyrinth seals and very little contact in brush seals.

In order to ensure good sealing of enclosures provided with labyrinth seals or with brush seals, it is nevertheless necessary to pass a flow of air through the seals, said flow of air generally being taken from a compressor stage of the engine. Having recourse to such a method also involves providing devices for separating the oil from the air that is to be exhausted to the outside of the engine. Such devices are commonly referred to as de-oilers and they are themselves well known. By way of example, reference may be made to documents U.S. Pat. No. 4,981,502 and U.S. Pat. No. 6,033,450 which describe various types of centrifugal de-oiler.

The use of a flow of air for ensuring that the enclosures of an engine are leaktight nevertheless raises a problem of optimizing the flow. It can readily be understood that the greater the flow of air passing through the seals, the better the enclosures are sealed. The counterpart of a large air flow is that a large quantity of oil exists in the air that is exhausted to the outside of the engine, which implies a high level of oil consumption. Furthermore, the flow rate of air taken from a compressor stage depends on the operating speed of the engine, such that the minimum flow rate needed to ensure that the enclosures are sealed is calculated on the basis of the engine idling (i.e. when the engine is operating at a speed during which the air-flow rate taken off is at its lowest). Thus, during other stages of operation of the engine, and in particular at full speed, the flow rate of air passing through the seals of the enclosures is excessive compared with the rate that would suffice to ensure that the enclosures are sealed, thereby leading to excess consumption of oil with the harmful effects that that involves (pollution, extra cost, etc.).

### OBJECTS AND SUMMARY OF THE INVENTION

The present invention seeks to remedy the above-mentioned drawbacks by proposing a de-oiler that is capable of ensuring good sealing of air/oil enclosures regardless of the stage of operation of the engine, while also guaranteeing the lowest possible consumption of oil.

This object is achieved by a centrifugal de-oiler of variable flow section, the de-oiler comprising: a hollow cylindrical shaft movable in rotation about its axis of revolution, the shaft having at least one air-passing orifice opening out into an air/oil enclosure and opening out into the inside of the shaft; and a piston housed inside the shaft so as to subdivide the inside of the shaft into two compartments that are sealed relative to each other, the compartment provided with the air-passing orifice(s) being subjected to ambient pressure and the other compartment being subjected to the varying pressure in the air/oil enclosure; the piston being suitable for moving in translation inside the shaft between two extreme positions under the effect of a pressure difference between the two compartments, the extreme positions comprising a first position in which the air-passing orifice(s) is/are disengaged, and a second position, different from the first position, in which the air-passing orifice(s) is/are partially obstructed by the piston.

In practice, the flow section for the air passing through the orifices in the de-oiler shaft is a function of the pressure difference between the pressure inside the air/oil enclosure and ambient pressure corresponding to the shaft being connected to the outside atmosphere. Thus, the greater the flow rate of air that passes through the seals of the air/oil enclosure, the higher the pressure inside the enclosure and thus the smaller the section that can be accepted for the air flowing into the de-oiler (i.e. the piston is moved towards its second position).

As a result, it is possible to vary the flow section for air in the de-oiler as a function of the pressure inside the air/oil enclosure, and thus to limit the flow rate of air passing through the seals to the minimum strictly necessary for sealing the enclosure. This results in low oil consumption in all stages of engine operation.

According to an advantageous provision of the invention, the piston comprises a shaft centered on the axis of revolution and suitable for sliding inside stationary rings for the purpose of guiding the piston axially. Under such circumstances, at least one of the rings forms an upstream axial abutment for the piston.

According to another advantageous provision of the invention, the de-oiler further includes an annular shoulder secured to the shaft and forming a downstream axial abutment for the piston.

According to yet another advantageous provision of the invention, the de-oiler further includes a spring wound around the shaft to keep the piston in its first position when the pressure in the air/oil enclosure is too low.

Each air-passing orifice may open out into the air/oil enclosure via a chimney extending in a direction that is substantially radial.

The invention also provides a gas turbine airplane engine including at least one centrifugal de-oiler as defined above.

### BRIEF DESCRIPTION OF THE DRAWINGS

Other characteristics and advantages of the present invention appear from the following description made with reference to the accompanying drawings that show an embodiment having no limiting character. In the figures:

FIG. 1 is a view showing a centrifugal de-oiler in accordance with the invention in exemplary surroundings;

FIG. 2 is a longitudinal section view of the FIG. 1 de-oiler in one of its two extreme positions; and

FIG. 3 is a longitudinal section view of the FIG. 1 de-oiler in the other one of its two extreme positions.

### DETAILED DESCRIPTION OF AN EMBODIMENT

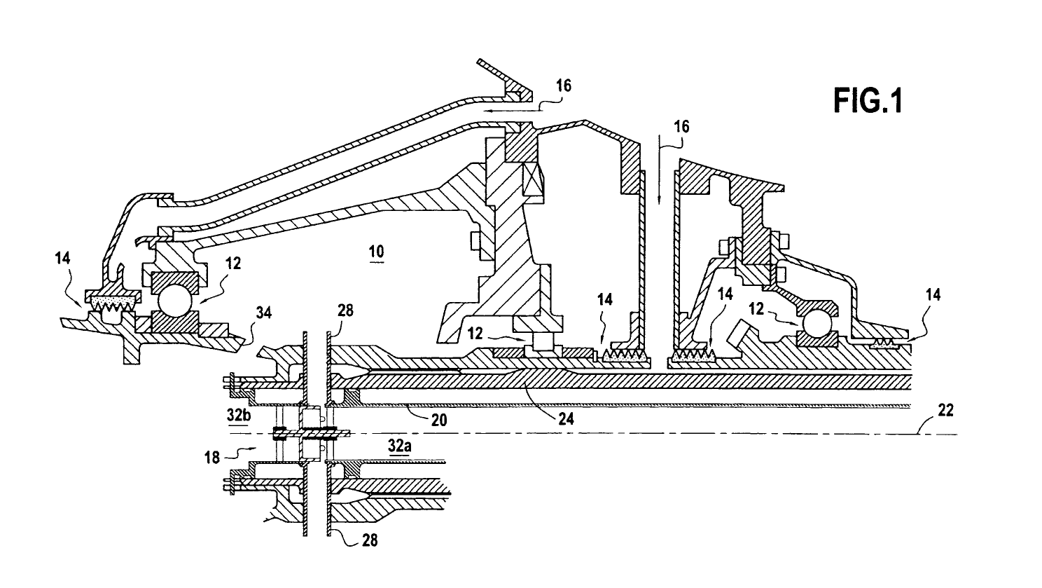

FIG. 1 is a longitudinal section view showing an air/oil enclosure 10 in a turbojet provided with a centrifugal de-oiler in accordance with the invention. Naturally, the present invention applies to other types of air/oil enclosure present in a gas turbine engine, e.g. to those present in the turbojet accessory drive gearbox.

The air/oil enclosure 10 contains in particular ball bearings 12 that need to be cooled and lubricated by continuously injecting oil between the rings of these bearings via injector nozzles (not shown in the figure). In an accessory drive gearbox, in addition to bearings, there are also gears that need to be cooled and lubricated by injecting oil.

In order to prevent oil leaking out from the air/oil enclosure 10, provision is made to locate seals 14 between the rotary portions and the stationary portions of the enclosure. In the example shown in FIG. 1, these seals are four in number and they are of the labyrinth type.

A flow of compressed air is introduced into the air/oil enclosure 10 via seals 14 in order to pressurize the enclosure and thus ensure that it is completely leaktight. By way of example, this flow of air comes from air taken from a compressor stage of the turbojet (represented by arrows 16 in FIG. 1).

The air/oil enclosure 10 also includes a centrifugal de-oiler 18 in accordance with the invention. In known manner, such a device serves to separate the oil from the air in the air/oil mixture that is present inside the enclosure 10, the air being exhausted outside the turbojet and the oil being reinjected into the enclosure.

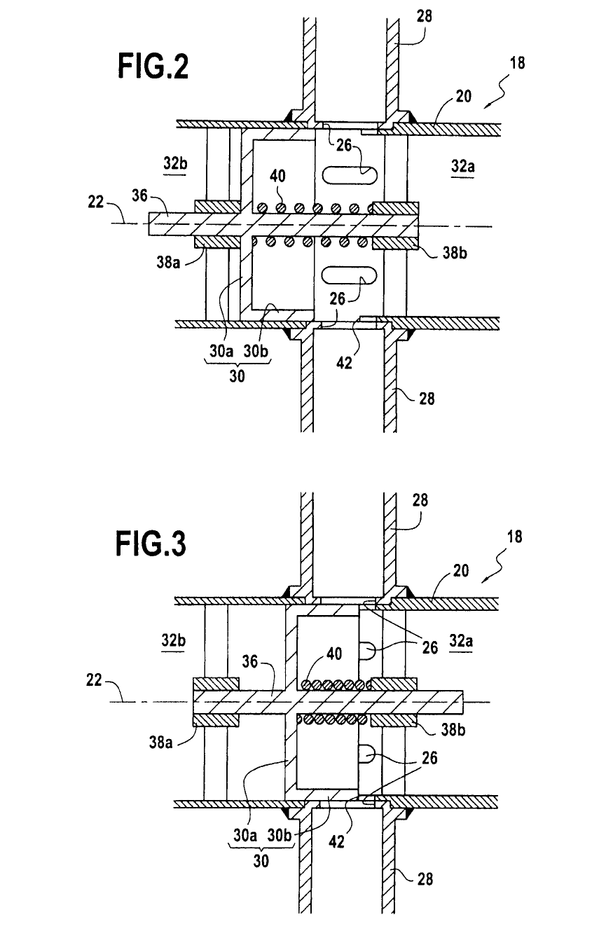

As shown in FIGS. 2 and 3, the de-oiler 18 comprises a hollow cylindrical shaft 20 that is mounted to rotate about its axis of revolution 22. By way of example, the shaft is driven in rotation directly by the main shaft 24 of the turbojet (see FIG. 1).

The hollow shaft 20 has a plurality of air-passing orifices 26 that open out into the air/oil enclosure 10 and that also open out into the hollow shaft. By way of example, and as shown in FIG. 2, these orifices 26 are of oblong shape and regularly distributed around the axis 22.

In the enclosure of FIGS. 1 to 3, the centrifugal de-oiler is of the chimney type, i.e. each of the air-passing orifices 26 opens out into the air/oil enclosure 10 via a chimney 28 extending in a direction that is substantially radial. Nevertheless, other types of de-oiler can be envisaged (honeycomb de-oiler, metal foam de-oiler, etc.).

In this de-oiler, oil is separated from air on the following principle: the air/oil enclosure 10 is at a pressure that is positive relative to the inside of the shaft, so the air/oil mixture present in the enclosure penetrates into the radial chimneys 28 of the de-oiler. Droplets of oil in suspension in this mixture are “captured” by the inside walls of the chimneys. Since the shaft 20 of the de-oiler is in rotation, and thus the chimneys 28 are also in rotation, the oil captured by the inside walls of the chimneys flows radially outwards under the effect of centrifugal force and thus returns into the air/oil enclosure 10. In parallel, the de-oiled air passes through the air-passing orifices 26 and flows inside the shaft towards the downstream end thereof in order to be exhausted out from the turbojet.

Still in the invention, a piston 30 is housed inside the hollow shaft 20 of the de-oiler. The piston comprises in particular a disk 30a that is centered on the axis of revolution 22 and that is extended at its periphery by an annular collar 30b.

The piston 30 of the de-oiler subdivides the inside of the shaft transversely into two compartments that are sealed relative to each other: a downstream compartment 32a that includes the air-passing orifices 26; and an upstream compartment 32b.

The downstream compartment 32a communicates directly with the outside of the turbojet (at the downstream end, not shown, of the main shaft 24 of the turbojet). It is therefore subjected to outside ambient pressure P1, which is substantially constant (when not changing altitude).

As for the upstream compartment 32b, it is put into communication with the air/oil enclosure 10 via one or more holes 34 (see FIG. 1). It is therefore subjected to the pressure P2 that exists inside the air/oil enclosure, this pressure varying with the flow of air entering into the enclosure through the seals 14.

Depending on the pressure difference between the two compartments 32a and 32b, the piston 30 of the de-oiler 18 is suitable for moving in translation inside the hollow shaft 20.

For this purpose, the piston 30 has a shaft 36 centered on the axis 22, secured to the disk 30a, and capable of sliding inside two stationary rings, an upstream ring 38a and a downstream ring 38b, thereby serving to guide the piston axially.

The de-oiler piston 30 is free to move in translation between two extreme positions: a first position shown in FIG. 2 in which the air-passing orifices 26 are completely disengaged (piston moved upstream), and a second position shown in FIG. 3, different from the first, in which the air-passing orifices are partially obstructed by the collar 30b (piston moved downstream).

The de-oiler piston 30 moves under the effect of the pressure difference between the two compartments 32a and 32b. More precisely, since the ambient pressure P1 inside the downstream compartment 32a is substantially constant (at unchanging altitude), the piston moves depending on the pressure level P2 that exists inside the air/oil enclosure 10.

According to an advantageous provision, the first position of the de-oiler piston 30 (FIG. 2) is defined by the upstream ring 38a forming an upstream axial abutment for the piston.

Furthermore, a spring 40 working in compression is wound around the shaft 36 of the piston and has one of its ends bearing against the disk 30a of the piston and its other end bearing against the downstream ring 38b. This spring serves to keep the piston in its first extreme position in the event of the pressure inside the air/oil enclosure being too low, thereby guaranteeing, in this situation, that a sufficiently large air-flow section exists to ensure that the air/oil enclosure is sealed by the seals 14.

According to another advantageous provision, the second position of the de-oiler piston 30 (FIG. 3) is defined by an annular shoulder 42 that forms a downstream axial abutment for the piston. This shoulder which is secured to the shaft 20 of the de-oiler forms a decrease in the diameter of the shaft, thus preventing any sliding of the piston beyond it.

Thus, when the pressure P2 inside the air/oil enclosure 10 becomes greater than a predetermined threshold pressure, the piston is kept in its second position in which the air-passing orifices 26 are partially obstructed. As a result, a minimum air-flow section is guaranteed whatever the pressure that exists inside the air/oil enclosure.

Likewise, when the pressure P2 inside the air/oil enclosure 10 is not sufficient to keep the piston 30 against the downstream abutment 42, then under drive from the spring 40 the piston returns into abutment against the upstream ring 38a thus leaving the air-passing orifices 26 fully open.

The operation of the de-oiler of the invention stems directly from the above description. The greater the flow of air passing through the seals 14 of the air/oil enclosure 10, the greater the pressure P2 inside the enclosure and the more the flow section for passing air to the de-oiler 18 will be reduced (by the piston 30 moving towards its second position). Conversely, when the turbojet is running slowly, the pressure P2 inside the air/oil enclosure is too low to move the piston 30 (which piston is kept in its first position by the spring 40), so the flow section for air flowing to the de-oiler 18 is at its maximum, thereby ensuring that the air/oil enclosure is sealed by its seals 14.

As mentioned above, the de-oiler may present various embodiments that are not shown in the figures. Thus, the above-described radial chimneys 28 could be replaced by a honeycomb structure or by a metal foam having cells that serve to collect the droplets of oil in suspension in the air/oil mixture.

1-7. (canceled)

8. A centrifugal de-oiler of variable flow section, the de-oiler comprising:
a hollow cylindrical shaft movable in rotation about its axis of revolution, the shaft including at least one air-passing orifice opening out into an air/oil enclosure and opening out into the inside of the shaft; and
a piston housed inside the shaft so as to subdivide the inside of the shaft into first and second compartments that are sealed relative to each other, the first compartment including the air-passing orifice(s) being subjected to ambient pressure and the second compartment being subjected to the varying pressure in the air/oil enclosure;
the piston configured to move in translation inside the shaft between two extreme positions under effect of a pressure difference between the first and second compartments, the extreme positions comprising a first position in which the air-passing orifice(s) is/are disengaged, and a second position, different from the first position, in which the air-passing orifice(s) is/are partially obstructed by the piston.

9. A de-oiler according to claim 8, wherein the piston comprises a shaft centered on the axis of revolution and configured to slide inside stationary rings to guide the piston axially.

10. A de-oiler according to claim 9, wherein at least one of the rings forms an upstream axial abutment for the piston.

11. A de-oiler according to claim 8, further comprising an annular shoulder secured to the shaft and forming a downstream axial abutment for the piston.

12. A de-oiler according to claim 9, further comprising a spring wound around the shaft to keep the piston in its first position when the pressure in the air/oil enclosure is too low.

13. A de-oiler according to claim 8, wherein each air-passing orifice opens out into the air/oil enclosure via a chimney extending in a direction that is substantially radial.

14. A gas turbine airplane engine comprising at least one centrifugal de-oiler according to claim 8.
